(19) United States
(12) Patent Application Publication
(10) Pub. No.: US 2010/0028622 A1
(43) Pub. Date: Feb. 4, 2010

(54) NONTHERMAL TRANSFER SHEET AND METHOD FOR MANUFACTURING THE SAME

(75) Inventor: Mitsuru Sato, Osaka-Shi (JP)

Correspondence Address: OSHA LIANG L.L.P., TWO HOUSTON CENTER, 909 FANNIN, SUITE 3500, HOUSTON, TX, 77010, US

(73) Assignee: YUTAKA SHOJI KAISHA, LTD., Osaka (JP)

(21) Appl. No.: 12/442,532

(22) PCT Filed: Aug. 27, 2007
(86) PCT No.: PCT/JP2007/066528

§ 371 Date: Mar. 24, 2009

(30) Foreign Application Priority Data
Sep. 26, 2006 (JP) 2006-260302

(51) Int. Cl. B44C 1/17; B32B 38/14; B65C 9/25; B32B 37/00

(52) U.S. Cl. 428/195.1; 156/277; 156/322; 156/60

(57) ABSTRACT

A nonthermal transfer sheet (11) usable for transfer to various types of objects including daily personal items such as clothing and the like and also human skin. In order to allow transfer to be realized without heating or pressurization, a transfer layer (33), which is or is not provided with a multi-color design layer (32) and is to be a main part of the nonthermal transfer sheet, and an adhesive layer (34) for pasting the transfer layer (33) to a transfer subject (51) are integrated together in advance by heating and pressurization. The transfer layer (33) is formed of a thermoplastic resin containing polyurethane as a main component, and therefore is highly flexible, extendable and transferrable even to human body. The adhesive layer (34) is formed of an adhesive containing an acrylic adhesive, and therefore is not reduced in the adhesive force and can be re-transferred (re-pasted). As a result, a wide range of transfer effects including decoration is provided. In addition, the nonthermal transfer sheet is easily removable and so is easily usable.

### TECHNICAL FIELD

The present invention relates to a transfer sheet usable for transferring an optional design or the like on a transfer subject, and more specifically to a nonthermal transfer sheet which can be used to transfer a design without heating or pressurization and can optionally be removed or re-transferred (re-pasted) as necessary.

### BACKGROUND ART

Thermal transfer sheets are disclosed in, for example, Japanese Laid-Open Patent Publications Nos. 11-34594, 2001-150883 and 2002-19390. These thermal transfer sheets are thermally compressed by an iron or the like for performing thermal transfer on a transfer subject such as a shirt or the like. These thermal transfer sheets aim at providing the transfer subject with a permanent effect of decoration or the like.

The thermal transfer sheets have basically the same structure, and include a design, a resin layer to be integrated with the design, and an adhesive layer for fixing the design on a transfer subject. These elements are provided on a substrate sheet. For transfer, the thermal transfer sheet is attached to the transfer subject such that a surface thereof on the adhesive layer side is in contact with the transfer subject, and the thermal transfer sheet is heated and pressurized by an iron or the like from the rear surface of the substrate sheet. Thus, the elements other than the substrate sheet are transferred to the transfer subject.

The design is printed by a printing system such as inkjet printing, toner printing or the like which can quickly respond to the request. Therefore, the thermal transfer sheets can be provided in small lots of many different types of design, and so enjoy a great demand.

However, these thermal transfer sheets require heating and pressurization for transfer, and are used only for a limited range of transfer subjects formed of materials which are durable against heating and pressurization.

The design or the like to be transferred needs to be absolutely durable for the purpose of transfer. This causes a problem that even when the design or the like becomes unnecessary, the sheet cannot be removed. In order to make the sheet removable, it is conceivable to weaken the adhesive force of the adhesive layer. However, even when the adhesive force is weakened, the sheet is not necessarily removed easily and cleanly depending on the properties of the transfer subject. There is an inconvenience that the transfer subject is damaged; for example, fibers on the surface of the transfer subject may come off, or the adhesive may partially remain on the transfer subject. Moreover, once the sheet is removed, the design or the like of the sheet cannot be reused (re-pasted).

Since the design or the like once transferred cannot be removed or reused as described above, it is impossible to deal with frequent changes of demands and preferences of increasing prospective consumers.

A tattoo seal disclosed in, for example, Japanese Laid-Open Patent Publication No. 2000-160111 is used for human skin. This tattoo seal allows any design desired by a user to be printed thereon by a printer. The tattoo seal includes a printable sheet allowing a design to be printed thereon and pasting means for pasting the printable sheet on the skin. The tattoo seal is used as follows. A design is printed on a surface of a printable layer of the printable sheet, and then a release paper of the pasting means is removed and the pasting means is pasted on the printable layer of the printable sheet. Then, the printable sheet is cut out into an optional shape, a release film of the pasting means is removed, and an adhesive layer is pasted on the skin. Finally, the printable sheet is removed, so that the printed design stays on the skin.

However, it is troublesome to paste and remove two sheets in this manner. As a tattoo seal requiring no such trouble, a tattoo seal which can be pasted with water is available. This tattoo seal includes a design or the like on a substrate sheet having high water absorptivity. A surface of the tattoo seal having the design or the like is attached to the skin, and the substrate sheet is sufficiently wetted with water. Then, the substrate sheet is shifted in a planar direction. As a result, the design or the like is left on the skin.

However, this tattoo seal uses water and so cannot be used everywhere. For example, soccer stadiums or other sports stadiums cannot permit use of this tattoo seal for cheering because there is a problem that the stadiums may get dirty.

In addition, erasing the design or the like pasted on the skin requires use of alcohol or the like and is not easy. Therefore, this type of tattoo seal is inappropriate for use by children.

### DISCLOSURE OF THE INVENTION

The present invention has an object of providing an easy-to-use nonthermal transfer sheet usable for transferring a design or the like to a wider variety of transfer subjects.

In order to achieve this object, the present invention includes a transfer layer, which is or is not provided with a design and is to be a main part of the nonthermal transfer sheet, and an adhesive layer for pasting the transfer layer to a transfer subject. The transfer layer is formed of a thermoplastic resin containing polyurethane as a main component, and the adhesive layer is formed of an adhesive containing an acrylic adhesive. The transfer layer and the adhesive layer are integrated together in advance by heating and pressurization.

Owing to this structure, the adhesive layer, among the integrated transfer layer and adhesive layer, adheres to the transfer subject to perform transfer. Transfer can be performed without heating or pressurization, and so can be performed to a variety of transfer subjects.

Examples of the transfer subject include clothing items such as shirts, pants, hats, socks, gloves, neckties, scarves, belts and the like; daily necessities such as bags, tote bags, CD (compact disc) cases, eye glasses, eye glass lenses, name tags, number cloths, stickers and the like; office supplies such as document organizers, plastic document binders, pens, pencil cases, notebooks and the like; bedding items such as pillow cases, cushion cases, bed sheets and the like; interior decoration items such as figurines, vases, pennants, and the like; tableware items such as glass cups and ceramic cups and the like; interior furnishing items such as curtains, wallpapers and the like; painting materials; books; furniture; electric appliances; and the like. Materials usable for the transfer subject include, for example, fiber, plastic, rubber, glass, leather, synthetic leather, ceramic, metal, paper, wood, vinyl, surfaces painted with general paints, and the like. The nonthermal transfer sheet according to the present invention is especially preferable for transfer to extendable or flexible materials. The nonthermal transfer sheet according to the present invention does not require heating or pressurization, and so is usable for transfer to human skin or the like, which is not conventionally usable as a transfer subject. Therefore, the nonthermal transfer sheet can be used as a substitute of a face painting material used when, for example, watching sports events.

In addition, the transfer layer, which is formed of a thermoplastic resin containing polyurethane as a main component, is flexible. Therefore, the transfer layer is easily adaptable to the transfer subject and extendable/contractable in compliance with the deformation of the transfer subject. Hence, the transfer layer has a texture not different from that of a general thermal transfer printing, and provides a desired effect of decoration or the like.

The adhesive layer, which is formed of an adhesive containing an acrylic adhesive, can be pasted to, and removed from, the transfer subject repeatedly and is unlikely to be reduced in the adhesive force. Moreover, after being subjected to a heating and pressurization treatment, the adhesive layer is made into a film and has an anchoring force to the transfer layer on the surface in contact with the transfer layer and thus is highly likely to be integral with the transfer layer. As a result, the adhesive layer does not damage the transfer subject by remaining on the transfer subject when being removed from the transfer subject.

Where the integrated assembly of the transfer layer and the adhesive layer has a certain level of thickness, it is possible to once remove and re-paste the assembly when, for example, the transfer becomes unnecessary or the assembly is pasted to a wrong position. In this case, the adhesive layer is integral with the transfer layer and does not remain on the transfer subject. The adhesive force of the adhesive layer is not reduced. The removing work is done by forcibly peeling off the design layer or the like, and can be easily done even by children.

Therefore, the nonthermal transfer sheet can deal with frequent changes of demands and preferences of prospective consumers or the like.

Since water is not used for transfer, the nonthermal transfer sheet is easy to use and usable at anywhere. Therefore, the nonthermal transfer sheet can be used as means for cheering when watching sports events without making the sports stadiums dirty, and so is highly valuable.

### BRIEF DESCRIPTION OF DRAWINGS

FIG. 1 provides a plan view of a nonthermal transfer sheet and a cross-sectional view schematically showing a cross-sectional structure of the transfer sheet.

FIG. 2 provides cross-sectional views schematically showing manufacturing steps of the nonthermal transfer sheet.

FIG. 3 is a plan view of FIG. 2(b) of the manufacturing steps.

FIG. 4 is a plan view of FIG. 2(c) or (d) of the manufacturing steps.

FIG. 5 provides cross-sectional views schematically showing transfer steps of the nonthermal transfer sheet.

FIG. 6 is a plan view of a transferred state of the nonthermal transfer sheet.

FIG. 7 provides plan views of a nonthermal transfer sheet in another example.

FIG. 8 is a plan view of a nonthermal transfer sheet in still another example.

FIG. 9 provides views showing a pasted/re-pasted state of the nonthermal transfer sheet.

FIG. 10 provides cross-sectional views schematically showing manufacturing steps of a nonthermal transfer sheet in still another example with no design layer.

FIG. 11 provides cross-sectional views schematically showing a cross-sectional structure of a nonthermal transfer sheet manufacturing tool.

FIG. 12 provides isometric views of the nonthermal transfer sheet manufacturing tool shown in FIG. 11.

FIG. 13 provides cross-sectional views schematically showing how to use the nonthermal transfer sheet manufacturing tool shown in FIG. 11.

FIG. 14 provides cross-sectional views schematically showing a structure of a nonthermal transfer sheet manufacturing tool in another example.

FIG. 15 provides plan views showing examples of how to use the nonthermal transfer sheet manufacturing tool shown in FIG. 14.

FIG. 16 provides a cross-sectional view and a plan view schematically showing a structure of a nonthermal transfer sheet manufacturing tool in still another example.

FIG. 17 provides cross-sectional views schematically showing how to use the nonthermal transfer sheet manufacturing tool shown in FIG. 16.

FIG. 18 is a cross-sectional view schematically showing a structure of a nonthermal transfer sheet manufacturing tool in still another example.

### BEST MODE FOR CARRYING OUT THE INVENTION

Hereinafter, an embodiment for carrying out the present invention will be described with reference to the drawings.

### EXAMPLE 1

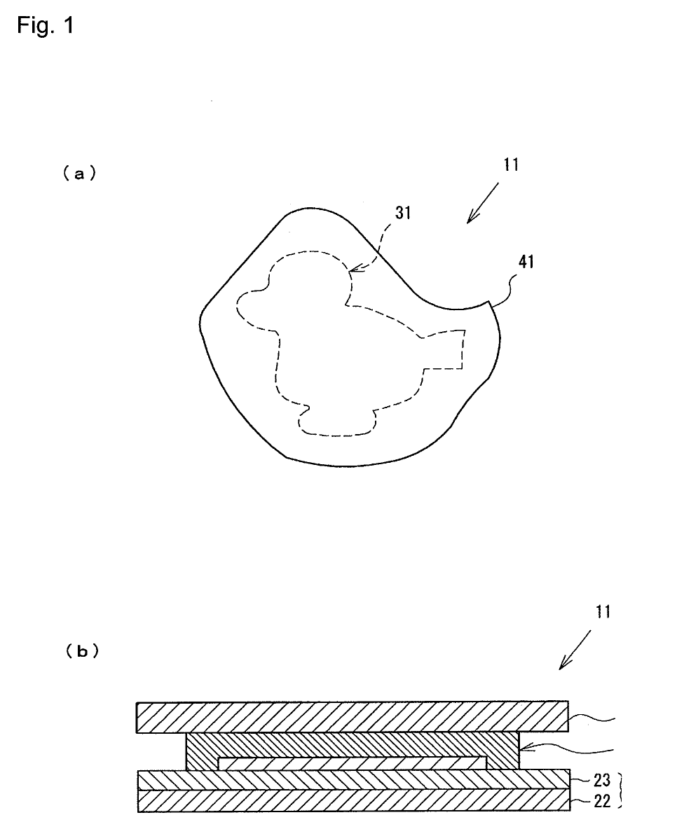

FIG. 1 shows a structure of a nonthermal transfer sheet 11 according to Example 1. FIG. 1(a) is a plan view thereof, and FIG. 1(b) is a cross-sectional view thereof. In order to clearly show the structure, all the figures are schematic with the thickness of each element being enlarged than an actual size thereof.

The nonthermal transfer sheet 11 includes a substrate sheet 21, a transfer design layer 31, and an adhesive layer protective sheet 41.

The substrate sheet 21 includes a substrate layer 22 and a release layer 23 formed thereon. The substrate sheet 21 needs to have properties including heat resistance required for heating and pressurization, water resistance and printer applicability required for printing, and the like.

The substrate layer 22 is optionally formed of, for example, a synthetic resin film of a polycarbonate resin, a polyethylene terephthalate resin, a polybutylene terephthalate resin or the like; a synthetic material sheet of synthetic paper or the like; a natural material sheet of high-quality paper, size-stabilized paper or the like; or a semi-synthetic material sheet of resin-immersed paper.

The release layer 23 is formed of any of various polymer resins usable for release layers including a silicone resin, an acrylic resin, a polyethylene resin, a fluoride resin and the like; or any of various releasing agents including wax and the like. As necessary, the material of the release layer is mixed with a different type of polymer resin, and also any of various types of additives including a thickener, a plasticizer, a penetrant, a humectant, a filler, an extender and the like.

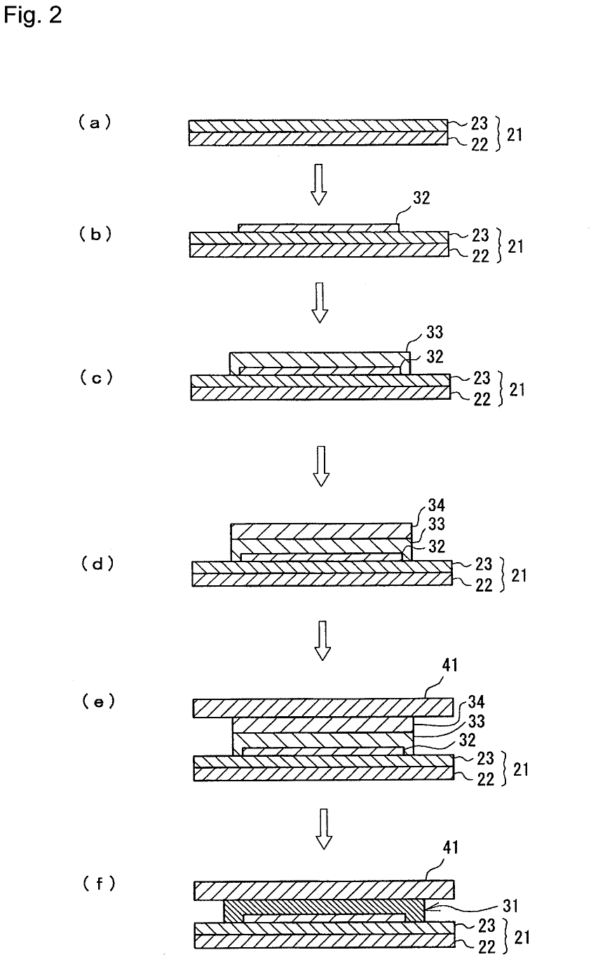

The transfer design layer 31 includes a multi-color design layer 32, a transfer layer 33 and an adhesive layer 34 (see FIG. 2). The multi-color design layer 32, the transfer layer 33 and the adhesive layer 34 are integrated together by a heating and pressurization treatment.

As shown in FIG. 2, the multi-color design layer 32 is an optional letter, geometric pattern, color pattern, graphic pattern or the like. The multi-color design layer 32 is formed by, for example, offset printing such as UV (ultraviolet fixing) offset printing or the like, dry color toner printing, screen printing, inkjet printing, any other appropriate printing, handwriting/hand drawing, stamping or the like. Namely, the multi-color design layer 32 is formed of an offset ink, a urethane-based or acrylic-based resin paste, a urethane-based or acrylic-based resin aqueous painting material, an alcoholic marker, a dye ink, a stamp ink or the like. The multi-color design layer 32 may be of a single color instead of a plurality of colors.

The transfer layer 33 is a main part of the nonthermal transfer sheet 11, and supports the multi-color design layer 32. The transfer layer 33 is formed of a thermoplastic material, as which a polyurethane resin is mainly used. Alternatively, for example, a polyester resin, a nylon resin, an EVA resin or the like is optionally usable, which is sufficiently flexible and water-resistant to hold the multi-color design layer 32 on the substrate sheet 21 and protect the multi-color design layer 32 until the heating and pressurization treatment is finished. The transfer layer 33 thus formed has a strong holding force of the multi-color design layer 32 after the heating and pressurization treatment and thus contributes to the formation of the transfer design layer 31 which is tough, water-resistant, abrasion-resistant and stretch-resistant.

To the thermoplastic material forming the transfer layer 33, any of various additives including a cross-linker, a thickener, a dispersant, an antiseptic, an antifoam, a humectant, a pH adjuster, a surfactant and the like is optionally added as necessary. With such an additive, the thermoplastic material forming the transfer layer 33 is adjusted in terms of the dispersability, dispersion stability, processability as a material forming the transfer layer 33, water resistance, abrasion resistance, stretch resistance or the like.

The adhesive layer 34 is for pasting the transfer layer 33 to a transfer subject. The adhesive layer 34 is formed of an acrylic adhesive, as which an acrylic ester copolymer is used. The acrylic ester copolymer can be pasted to, and removed from, the transfer subject repeatedly and is not likely to be reduced in the adhesive force. A main component of the acrylic ester copolymer is a known acrylic monomer copolymer; more specifically, a copolymer of three types of monomers of acrylic esters having different properties as follows: a monomer contributing to adhesiveness such as acrylic diethylhexyl or the like, a monomer contributing to cohesiveness such as acrylonitrile or the like, and a monomer having a functional group (hydroxyl group, amino group, etc.) reactive with a cross-linker.

The adhesive layer 34 has a strong adhesiveness on a surface thereof (the surface not to be in contact with the transfer layer) in a naturally dried state. After being subjected to the heating and pressurization treatment, the adhesive layer 34 is made into a film and has an anchoring force to the transfer layer on a surface contacting the transfer layer. Therefore, the adhesive layer 34 does not come off from the transfer layer 33, or does not stay on the transfer subject when being removed after transfer. Thus, the transfer subject is prevented from being damaged.

To the acrylic adhesive, any of various additives including a thickener, a dispersant, an antiseptic, an antifoam, a humectant, a pH adjuster, a surfactant and the like is added. With such an additive, the acrylic adhesive is optionally adjusted in terms of the dispersability, dispersion stability, processability as a material forming the adhesive layer 34 and the like as necessary. Especially when it is desired to improve the cohesiveness, durability, water resistance, anchoring force to the transfer layer, and releasability from the transfer subject of the adhesive layer 34, a cross-linker or a trace amount of thermoplastic resin may be added.

The adhesive layer protective sheet 41 is for protecting the adhesive layer when the transfer design layer is formed by the hearting and pressurization treatment. Therefore, the adhesive layer protective sheet 41 is formed to have a size sufficiently covering the transfer design layer 31 and has a release layer on one surface thereof although not shown. Like the substrate sheet 21, the adhesive layer protective sheet 41 is formed of, for example, a synthetic resin film of a polycarbonate resin, a polyethylene terephthalate resin, a polybutylene terephthalate resin or the like; a synthetic material sheet of synthetic paper or the like; a natural material sheet of high-quality paper, size-stabilized paper or the like; or a semi-synthetic material sheet of resin-immersed paper.

Manufacturing steps of the nonthermal transfer sheet 11 including such elements will be described, hereinafter.

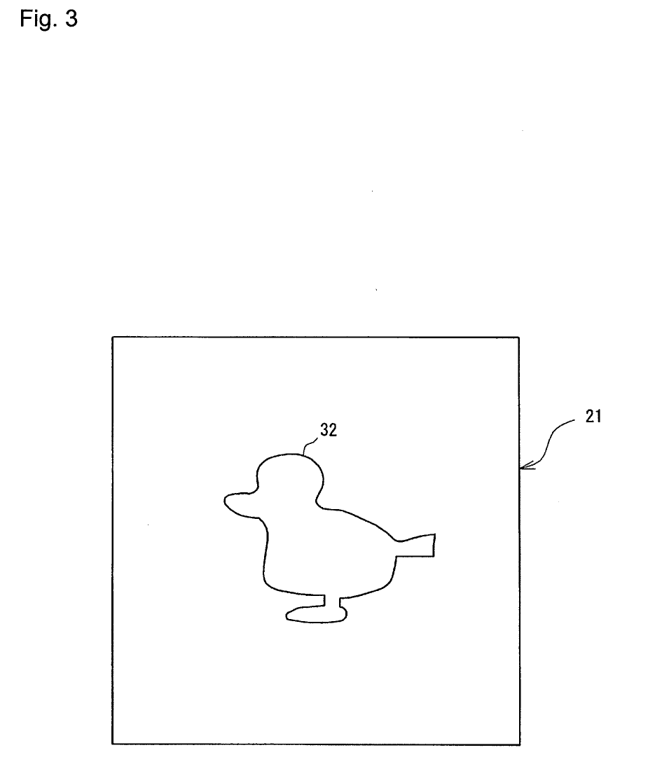

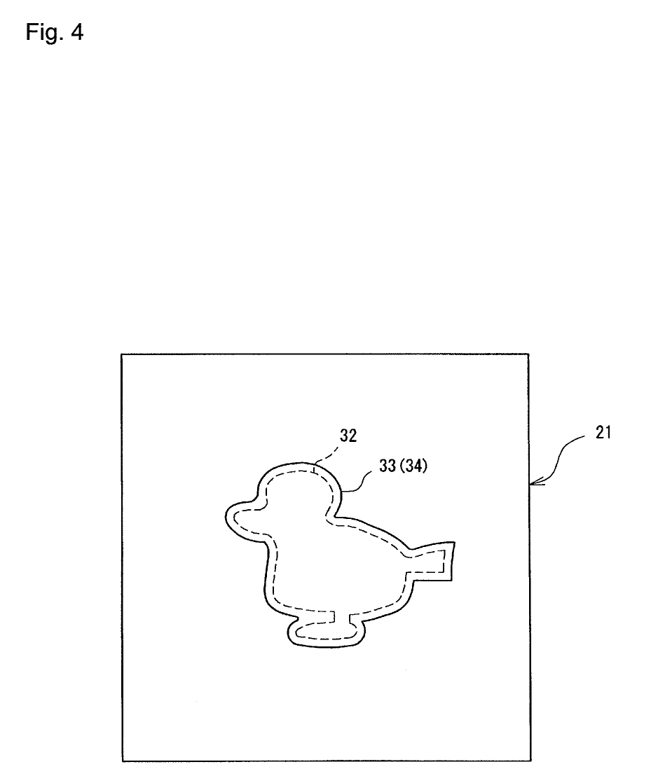

For manufacturing, the substrate sheet 21 is first prepared (see FIG. 2(a)). On a surface of the release layer 23 of the substrate sheet 21, the multi-color design layer 32 of an optional design is formed by printing or handwriting/hand drawing (see FIG. 2(b) and FIG. 3). Next, on the multi-color design layer 32, the transfer layer 33 and the adhesive layer 34 are formed sequentially. The transfer layer 33 is formed by, for example, applying the material by squeezing about 1 through 3 times using a screen (dried after each squeezing) (see FIG. 2(c) and FIG. 4). After the transfer layer 33 is formed, the adhesive layer 34 is formed by applying the material by squeezing, for example, about once, like the transfer layer 33 (see FIG. 2(d) and FIG. 4).

Next, the adhesive layer protective sheet 41 mentioned above is put on the adhesive layer 34 in the state where the release layer faces the adhesive layer 34, and the heating and pressurizing treatment is performed using a machine (see FIG. 2(e)).

By performing the heating and pressurizing treatment in this manner, the transfer layer 33 and the adhesive layer 34 are integrated together, and as a result, the transfer design layer 31 including the multi-color design layer 32 is formed.

The nonthermal transfer sheet 11 thus manufactured is used after being cut out into an optional shape as necessary.

Now, a specific example will be described.

For the substrate 21, a known and ready-made release paper conventionally used for adhesive sheets or liner of seals was used. For the substrate layer 22, high-quality paper was used. For the release layer 23, any of the above-mentioned resins having releasability was applied.

For the transfer layer 33, the following components were used. As the thermoplastic resin, a formulation containing a polyester urethane emulsion as a main component (PUE-1000; product number by Kabushiki Kaisha Murayama Kagaku Kenkyusho) was used. The following additives were used. As the thickener, a formulation containing an acrylic ester copolymer (HV-1000; product number by Kabushiki Kaisha Murayama Kagaku Kenkyusho) was used, and as the cross-linker, an isocyanate-based emulsion type cross-linker (Fixer 410; product number by Kabushiki Kaisha Murayama Kagaku Kenkyusho) was used. In addition, an antiseptic, an antifoam, a humectant, a pH adjuster and a surfactant were used.

For the adhesive layer 34, the following components were used. As an acrylic adhesive solution, an acrylic ester copolymer emulsion containing an acrylic monomer copolymer as a main component (TAC 22C; product number by Kabushiki Kaisha Murayama Kagaku Kenkyusho) was used. As an adhesiveness adjuster for improving the adhesive force of the adhesive layer 34, a formulation also containing an acrylic monomer copolymer as a main component but having a higher content of monomers contributing to the adhesiveness (MC COAT No. 79; product number by Kabushiki Kaisha Murayama Kagaku Kenkyusho) was used.

The multi-color design layer 32 was formed by two types of printing, i.e., screen printing and dry color toner printing. The former was performed as follows. An acrylic rubber glue, which is an acrylic resin paste containing a pigment and is used for common hand printing, and 100-mesh hand printing screens block-processed for each color were prepared. One screen was used for each color, and hand squeezing was performed once for each color. As a result, the multi-color design layer 32 was formed as a mirror image. For the printing, the substrate sheet 21 was secured to a hand printing table or the like having a low level of adhesiveness in order to prevent the multi-color design layer 32 from coming off from the substrate sheet 21 as a result of, for example, the substrate sheet 21 being waved by air.

The latter printing was performed as follows. A commercially available dry color toner printer and dry color toners manufactured especially for this printer were used, and the multi-color design layer was formed as a mirror image. For the printing, the heating temperature for fixing the toners was set to be slightly higher, and the printing rate was set to be slightly lower, than for printing performed on plain paper. In addition, for the sheet feeding inside the printer from the start of printing until the sheet discharge, the substrate sheet 21 was set to advance straight while the surface of the substrate sheet 21 on which the multi-color design layer 32 was to be formed was directed right upward. With such conditions, the surface of the release layer 23 was made suitable to color toner printing.

The printing state on the substrate sheet 21 (release layer 23) was generally good both in the screen printing and the dry color toner printing.

The substrate sheet 21 used had a thickness of about 90 μm. The thickness of the multi-color design layer 32 formed was about 10 μm by screen printing and was about 15 μm by color toner printing.

The transfer layer 33 was formed as follows. The material for the transfer layer 33 was applied to the multi-color design layer 32 by hand squeezing using a block-processed 100-mesh screen, and naturally dried. The material was applied twice. The transfer layer 33 thus formed had a thickness of about 50 μm. The transfer layer 33 entirely exhibited slight flexibility and removal resistance and did not come off unnecessarily.

The adhesive layer 34 was formed as follows. The material for the adhesive layer 34 was applied once to the transfer layer 33 by hand squeezing using the same screen as used for forming the transfer layer 33, and naturally dried. The adhesive layer 34 thus formed had a thickness of about 30 μm. The adhesive layer 34 exhibited strong adhesiveness right after being dried. At this stage, the adhesive layer 34 was not yet made into a film and was not very durable, and so was likely to come off from the transfer layer 33. For this reason and also for performing the subsequent heating and pressurization treatment, the adhesive layer protective sheet 41 sufficiently large to cover the entire adhesive layer 34 on the substrate sheet 21 was put on the adhesive layer 34.

In order to provide the adhesive layer protective sheet 41 with a higher releasability than that of the release layer 23 of the substrate sheet 21, the adhesive layer protective sheet 41 was formed to include a known and ready-made release paper mainly usable for liners of adhesive seals, and was put such that the release paper would be in contact with the adhesive layer. At this stage, the adhesive layer protective sheet 41 was merely put on the adhesive layer 34 and was not fixed at all.

The heating and pressurization treatment was performed using a commercially available thermal transfer press machine (with a heating iron on one side). The heating and pressurization conditions were a temperature of 150° C., a time period of 18 seconds, and a pressure of about 400 g/cm².

With the nonthermal transfer sheet 11 thus manufactured, the thickness of the transfer design layer 31 became about 40 μm as a result of being pressed. Since the thickness of the thermal protective sheet 41 was about 90 μm like that of the substrate sheet 21, the entire thickness was about 220 μm. However, the entire sheet was flexible and easy to handle, and was not wrinkled or waved. The transfer design layer 31 was made tough as a result of the elements thereof being integrated together through the heating and pressurization treatment. On the surface of the transfer design layer 31 facing the substrate sheet 21, the multi-color design layer 32 was firmly formed; and on the opposite surface of the transfer design layer 31, the adhesive layer 34 made into a film by thermal plasticization was fixed. The adhesive layer 34 and the adhesive layer protective sheet 41 were in a state of stably adhering to each other as a result of the heating and pressurization treatment so as not to come off from each other unnecessarily.

The entire process from the formation of the multi-color design layer 32 until the thermal pressing, and the nonthermal transfer sheet 11 as a finished product, did not generate any gas or abnormal smell caused by a solvent, a resin or the like.

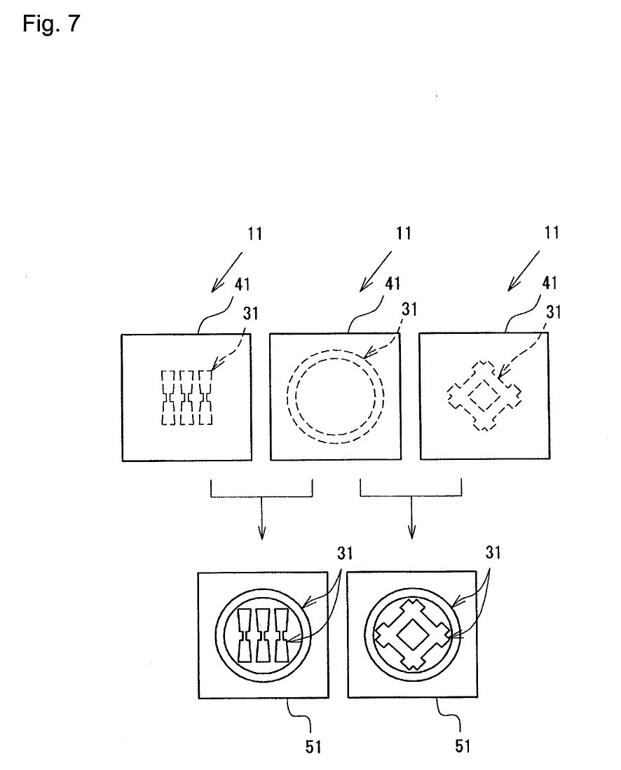

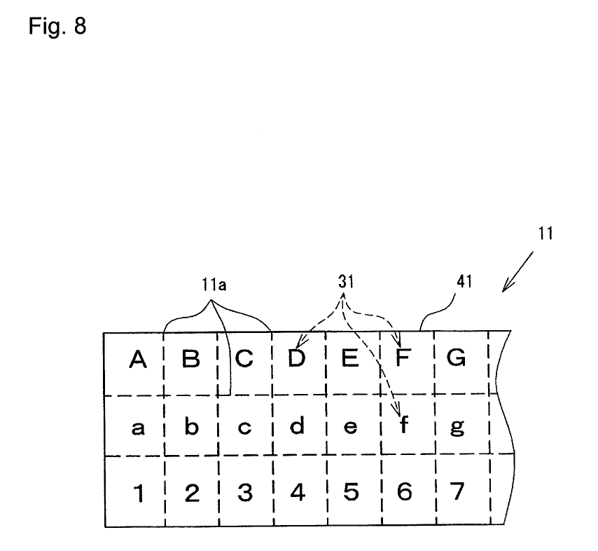

The nonthermal transfer sheet 11 is not limited to having one design in one transfer layer 31. For example, as shown in FIG. 7 and FIG. 8, a plurality of transfer layers 31 may have different designs, which can be used in combination. The transfer design layers 31 of the nonthermal transfer sheet 11 shown in FIG. 7 each have a part of a family crest. By optionally combining such transfer design layers, various family crests can be formed. The user's original family crest patterns can be formed and combined, instead of existing family crests. The transfer design layer 31 of the nonthermal transfer sheet 11 shown in FIG. 8 has letters and numerical figures. In FIG. 8, reference numeral 11a represents perforations, and each letter or each numerical figure can be cut out.

The nonthermal transfer sheet is used (transferred) as follows.

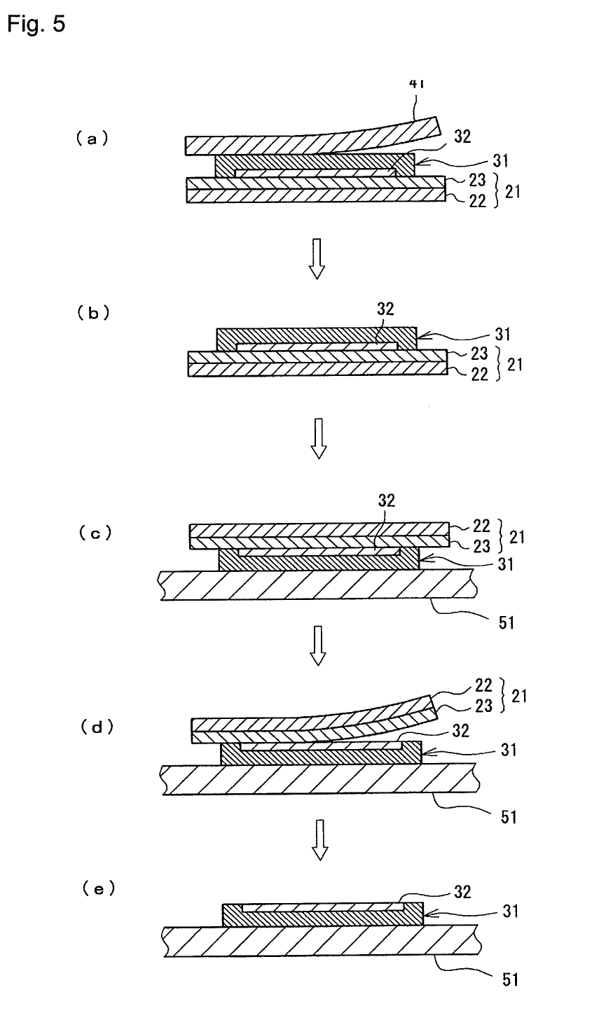

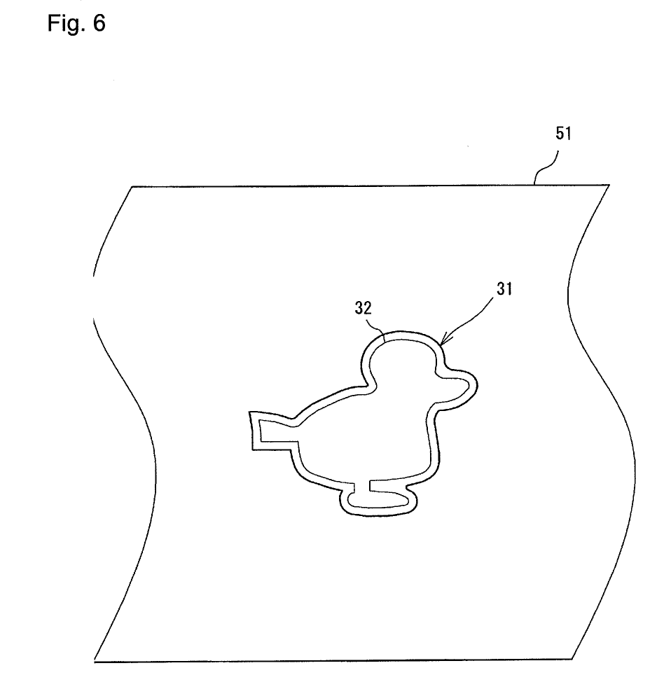

First as shown in FIG. 5(a), the adhesive layer protective sheet 41 is peeled off by fingers to expose the surface of the transfer design layer 31 on the adhesive layer 34 side (see FIG. 5(b)). Next, the substrate sheet 21 and the transfer design layer 31 are put inside out, and put on a transfer subject 51 (see FIG. 5(c)). The substrate sheet 21 located on top is rubbed toward the transfer subject 51 with a relatively hard member such as a finger nail or the like (not shown). As a result, the transfer design layer 31 adheres to the transfer subject 51. Then, the substrate sheet 21 is removed (see FIG. 5 (d)). Thus, the transfer design sheet 31 is left on the transfer subject 51 and the transfer is completed (see FIG. 5(e) and FIG. 6).

In the case where the substrate sheet 21 is hard to be removed and the transfer design layer 31 may be possibly removed together with the substrate sheet 21 from the transfer subject 51, the following arrangement may be made. Immediately before putting the nonthermal transfer sheet 11 for transfer, shallow cuts are made in the substrate sheet 21 toward the transfer design layer 31. With this arrangement, the substrate sheet 21 can be torn and taken out, and so is easily removable.

The post-transfer state of the nonthermal transfer sheet 11 obtained in the above-described specific example will be described.

From the manufactured nonthermal transfer sheet 11, a necessary part of each transfer design layer was cut off and transferred as follows.

As the transfer subjects 51, a white cotton knit cloth, a polypropylene document binder, and a copy paper were prepared. Then, the adhesive layer protective sheet 41 was peeled off from the nonthermal transfer sheet 11 with fingers, and the remaining part of the nonthermal transfer sheet was put on each transfer subject 51 such that the transfer design layer 31 would be in contact with the transfer subject 51.

Next, the entirety of the substrate sheet 21 of the nonthermal transfer sheet 11 was rubbed toward each transfer subject 51 with a finger nail or a non-ink tip of a ballpoint pen about ten times. Then, the substrate sheet 21 was peeled off by fingers to obtain the transfer design layer 31 on each transfer subject 51. The image quality of the transfer design layer 31 was good, and the printing quality of the multi-color design layer 32 was reproduced almost in the same state as when it was formed.

The transfer design layer 31 did not come off from each transfer subject 51 unnecessarily. The design was not chipped off even when the surface of the transfer design layer 31 was slightly rubbed with a finger nail, a coin or the like on the desk. Owing to the thinness (about 40 to 40 μm) and high flexibility of the transfer design layer 31, the white cotton knit cloth exhibited a texture not different from that of a common thermal transfer printing when extended or folded. The document binder and the copy paper exhibited a texture not different from that of printing almost at all.

Next, the transfer design layer 31 was peeled off by fingers. Any of the transfer subjects 51 was not damaged. The post-peeling transfer design layer 31 in a film state was allowed to be pasted again in the same state. The transfer design layer 31 after being thus pasted was not reduced in the properties. The transfer design layer 31 was allowed to be removed and pasted in repetition.

After transfer design layer 31 was removed from, and pasted on, the white cotton knit cloth many times, a small amount of fiber was attached to the adhesive layer 34 of the transfer design layer 31. After the transfer design layer 31 was lightly washed with flowing water and fingers, the fiber came off. When the transfer design layer 31 was sufficiently dried and pasted again, a good adhesive state was obtained. It was also possible to remove the transfer design layer 31 with flowing water. In this case, almost no fiber was attached.

The transfer state was observed for several months. Neither change in the properties of the transfer design layer 31 (wrinkles, stretching, shrinkage, cracks, etc.) nor adhesiveness reduction was recognized.

The transfer layer 33 of the transfer design layer 31 thus transferred contains polyurethane as a main component and so has high flexibility and stretch resistance. Therefore, the transfer design layer 31 is well adapted to the shape change of the transfer subject 51 and maintains the same decoration effect even when the transfer subject is stretched, wrinkled or folded slightly. The adhesive layer 34 contains an acrylic adhesive, and therefore is unlikely to be reduced in the adhesiveness and can be re-pasted. Hence, the adhesive layer 34 does not easily come off although this depends on the conditions of use and the usage of the transfer subject 51.

Since any of various things including human skin is conceivable as the transfer subject 51, the nonthermal transfer sheet 11 is usable in a wide range of applications.

In addition, since the transfer design layer 31 can be easily peeled off by fingers, the nonthermal transfer sheet 11 can be used safely by children. As well as being forcibly peeled off by fingers, the transfer design layer 31 can be, for example, exposed to flowing water (cool water) at the faucet of the water pipe to naturally be removed by water pressure or the like depending on the adhesive force of the adhesive layer 34. Therefore, when the transfer design layer 31 is transferred (pasted) to, for example, a home-washable clothing item, the transfer design layer 31 is naturally removed by being washed as usual after being worn. Therefore, the transfer design layer 31 can be removed without any extra time or labor and can be used for clothing of daily use. The transfer design layer 31 naturally removed can be collected together with other garbage from the washing machine tub after water is removed.

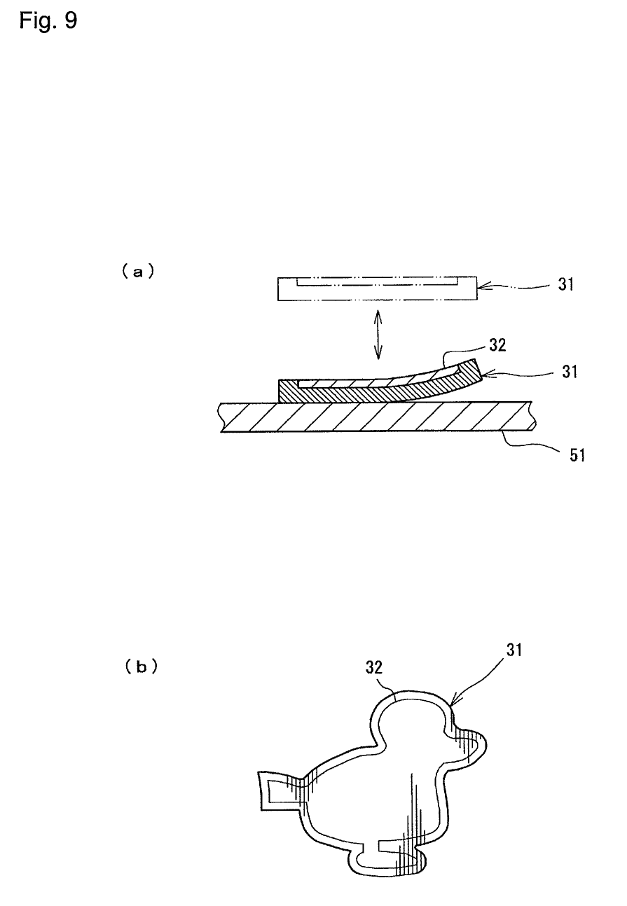

The transfer subject 51 is not damaged when the transfer 31 is removed. Therefore, the nonthermal transfer sheet 11 may be transferred to clothes for sale which are to be exhibited at the store, so that a temporary effect for display, decoration or advertisement can be provided. The transfer subject 51 is not damaged and it does not cause the purchaser any heavy trouble to remove the transfer design layer 31. Hence, the store can make various arrangements to the products for sale, which improves the selling effect as compared with the conventional tags or stickers.

Where the transfer design layer 31 has a certain level of thickness, for example, is as thick as at least 30 to 40 μm, the transfer design layer 31 can be easily peeled off by fingers and also reused (re-pasted) (see FIG. 9).

The transfer design layer 31 which is removed or comes off from the transfer subject 51 and is in a film state is slightly influenced by objects (fibers, dust, sweat, etc.) which is attached to the adhesive layer 34 from the transfer (paste) surface, but keeps the fundamental adhesive force thereof. Therefore, the transfer design layer 31 is reusable (can be pasted) as necessary. When the transfer design layer 31 is peeled off by fingers or the like instead of coming off by the water pressure as described above, the film may be slightly stretched. Nonetheless, where the stretching is slight, the transfer design layer 31 is naturally recovered to the original state owing to the elastic recovery force of the transfer design layer 31 itself.

When a great amount of object is attached to the adhesive layer 34 of the transfer design layer 31 or when the transfer design layer 31 is curled or heavily creased, the following arrangement may be made. The adhesiveness of the adhesive layer 34 is temporarily lost when the transfer design layer 31 is immersed in water or exposed to flowing water. Therefore, the transfer design layer 31 is lightly pinched by fingers while being immersed in water, and the adhesive layer 34 is wiped so as to smooth out the wrinkles. By this arrangement, the transfer design layer 31 can be cleaned and also recovered to the original shape.

When the transfer design layer 31 is to be reused after being washed with water, the transfer design layer 31 may be put on a horizontal smooth surface with the adhesive layer 34 being directed upward, and naturally dried. Preferably, for drying, the transfer design layer 31 is underlain by a paper sheet or resin sheet having substantially the same size as that of the transfer design layer 31, or by the substrate sheet 21, which has been removed and thus is reused. In this way, the transfer design layer 31, after being dried, can be pasted more easily than in the case where the transfer design layer 31 is directly pinched by fingers.

For pasting the transfer design layer 31, the transfer design layer 31 is put on the transfer subject such that the adhesive layer 34 of the transfer design layer 31 is in contact with the transfer subject, and then the transfer design layer 31 is lightly rubbed or pushed with fingers or the like via the paper or resin sheet or directly. Thus, the transfer design layer 31 can be pasted in substantially the same state as at the first time.

### EXAMPLE 2

In the following examples, identical or substantially identical elements as those of Example 1 will bear identical reference numeral therewith and detailed descriptions thereof will be omitted.

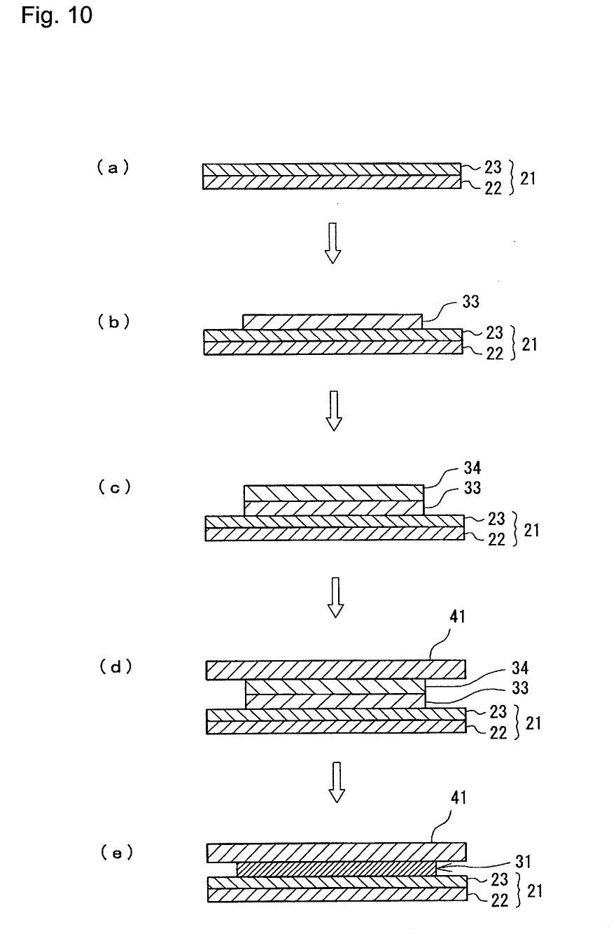

FIG. 10 provides cross-sectional views showing manufacturing steps of a nonthermal transfer sheet 11 according to Example 2.

A transfer design layer 31 of the nonthermal transfer sheet 11 in this example includes a transfer layer 33 and an adhesive layer 34, and does not include a multi-color design layer or a single color design layer. In this case, where the transfer layer 33 and the adhesive layer 34 have light transmissivity, the design cannot be represented. Therefore, a concealing substance is used so that a design is represented by the shape of the transfer layer 33 and the adhesive layer 34.

On a release layer 23 of a substrate sheet 21 as shown in FIG. 10(a), the transfer layer 33 is formed by, for example, using substantially the same means as in Example 1 (see FIG. 10(b)). Next, on the transfer layer 33, the adhesive layer 34 is formed in the same shape as that of the transfer layer 33 (see FIG. 10(c)).

To either one, or both of, the transfer layer 33 and the adhesive layer 34, a concealing substance is added. As the concealing substance, titanium oxide, aluminum silicate, or the like which exhibits a white color can be used. Such a substance is added at about 20 to 25%.

Note that where such a substance is added to the adhesive layer 34, the cohesive force or adhesive force of the adhesive layer 34 is reduced. Therefore, it is preferable to add an adhesiveness adjuster or an isocyanate-based emulsion cross-linker together with the concealing substance for improving the adhesive force.

The durability or water resistance of the adhesive layer 34 is certainly increased by extending the time for the heating and pressurization treatment by about several seconds or by adjusting the temperature for such a treatment to be slightly higher, rather than by using the cross-linker. It is also preferable to, before the heating and pressurization treatment, dry the nonthermal transfer sheet 11 by, for example, warm air of about 60 to 80° C. for 10 to 20 minutes using a drying cabinet or the like. By this arrangement, the adhesive layer can generally be improved in the durability and the anchoring force to the transfer layer.

After the transfer layer 33 and the adhesive layer 34 are formed on the release layer 23 of the substrate sheet 21, an adhesive protective layer 41 is put thereon as shown in FIG. 10(d), and the resultant assembly was subjected to a hearing and pressurization treatment by substantially the same means as in Example 1. As a result, the transfer design layer 31 including the transfer layer 33 and the adhesive layer 34 integrated together is formed as shown in FIG. 10(e).

The nonthermal transfer sheet 11 thus manufactured is used in substantially the same manner, and provides substantially the same function and effect, as in Example 1.

### EXAMPLE 3

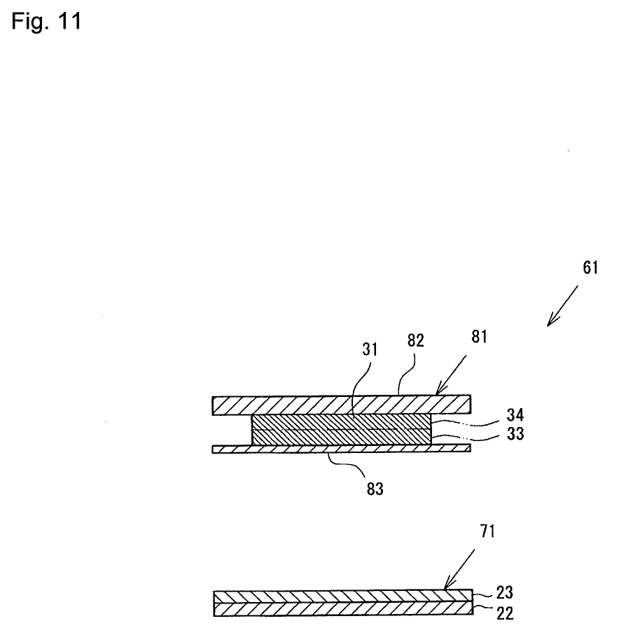

FIG. 11 provides cross-sectional views schematically showing a structure of a nonthermal transfer sheet manufacturing element 61 used for manufacturing a nonthermal transfer sheet 11 according to Example 3.

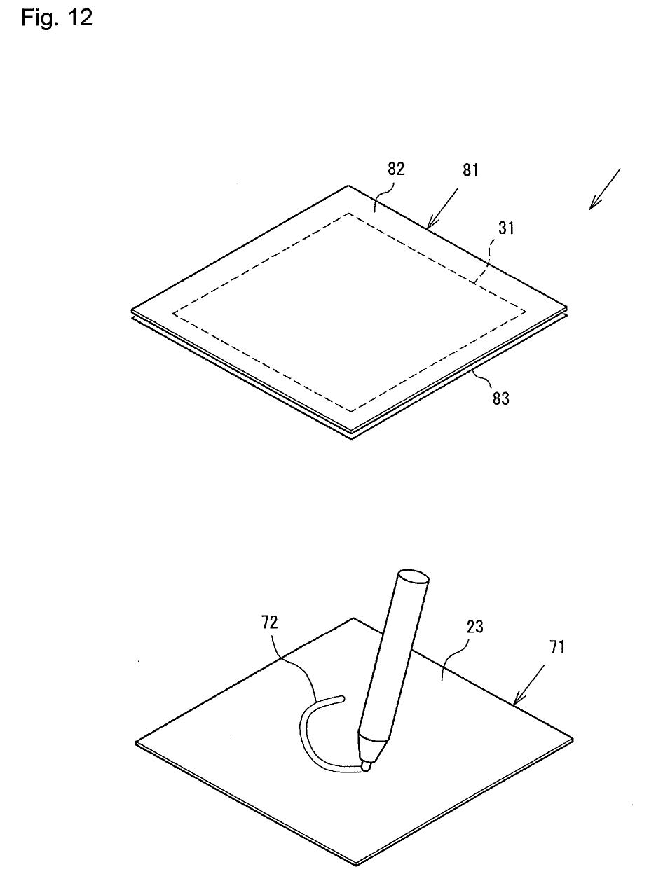

The nonthermal transfer sheet manufacturing element 61 is suitable to obtain a transfer design layer 31 desired by a user. Specifically, the nonthermal transfer sheet manufacturing element 61 includes a substrate sheet element 71 and a cover sheet element 81. A design 72 (see FIG. 12) made by, for example, hand drawing on the substrate sheet element 71 is integrated with a transfer layer 33 of the cover sheet element 81 to form the transfer design layer 31.

The substrate sheet element 71 includes a substrate layer 22 and a release layer 23 formed thereon, and has the same structure as that of the substrate sheet 21 in Example 1.

The cover sheet element 81 includes a sheet-like body 82 having a release layer (not shown) formed on a surface thereof, like the adhesive layer protective sheet 41 in Example 1. On the release layer of the sheet-like body 82, an adhesive layer 34 and the transfer layer 33 are formed in this order. The structure of the adhesive layer 34 and the transfer layer 33 is substantially the same as that of Example 1. The size of the adhesive layer 34 and the transfer layer 33 are appropriately adjusted so as to be larger than the design formed on the substrate sheet element 71. For example, the adhesive layer 34 and the transfer layer 33 may have an optional shape of an abstract or realistic design.

The adhesive layer 34 and the transfer layer 33 are lightly integrated together by a heating and pressurization treatment. Such integration may be performed, for example, at about 120° C. for about 5 to 10 seconds, i.e., more lightly than the full-fledged integration described in Example 1 which is performed at about 150° C. for about 18 seconds.

The transfer layer 33 is covered with a release sheet 83 for protecting the transfer layer 33.

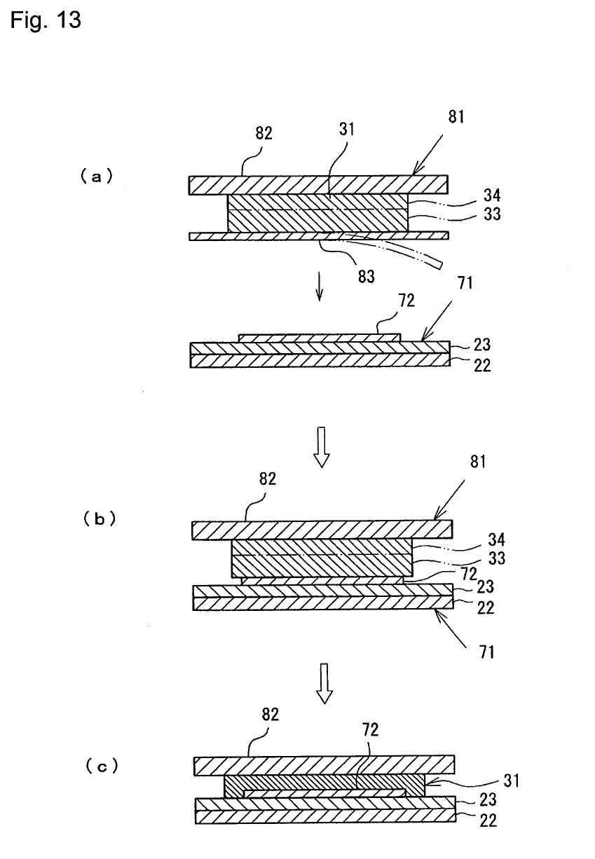

With the nonthermal transfer sheet manufacturing element 61 including such two elements, the design 72 desired by the user is formed on the release layer 23 of the substrate sheet element 71 using appropriate means as shown in FIG. 12. After this, the release sheet 83 of the cover sheet element 81 is removed (see FIG. 13(a)). Then, the transfer layer 33 of the cover sheet element 81 is put on the design 72 of the substrate sheet element 71 (see FIG. 13(b)), and the resultant assembly is subjected to a heating and pressurization treatment. As a result, the adhesive layer 34 and the transfer layer 33 which are integrated lightly in advance are integrated in a full-fledged state, and also the design is incorporated into the transfer layer 33. Thus, the nonthermal transfer sheet 11 having an integrated transfer layer 31 is formed (see FIG. 13(c)).

The nonthermal transfer sheet 11 manufactured using the nonthermal transfer sheet manufacturing element 61 is used in substantially the same manner, and provides substantially the same function and effect, as in Example 1.

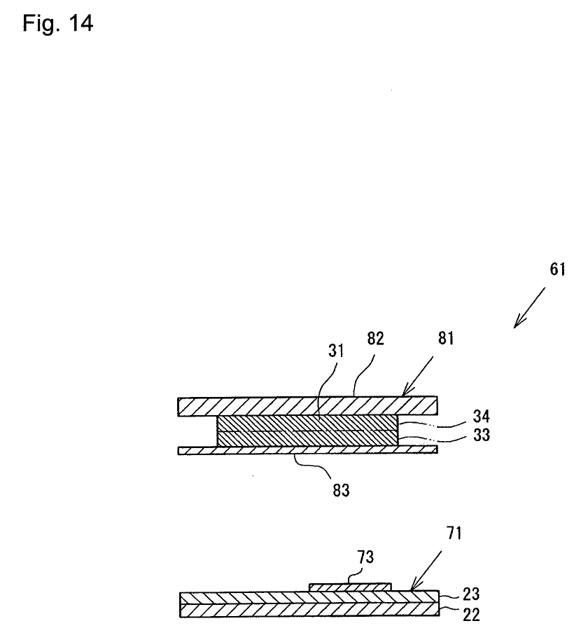

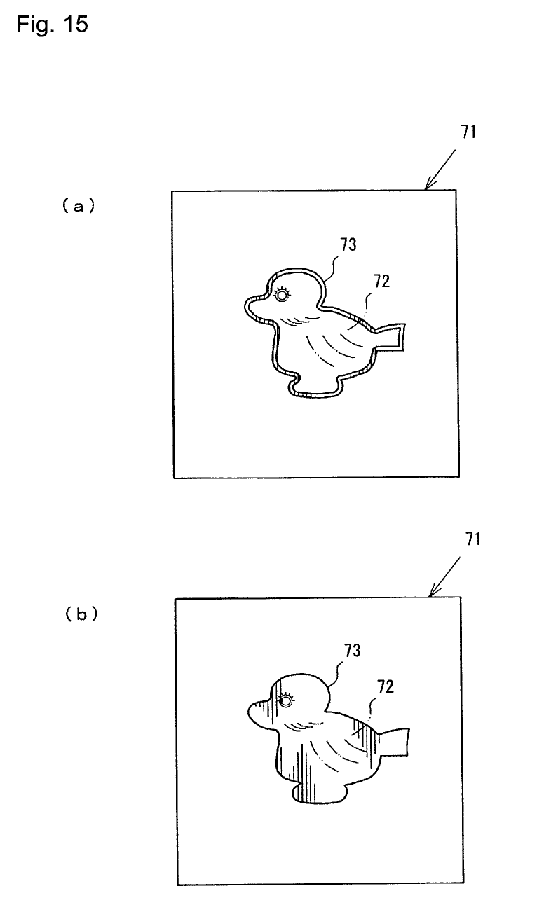

As shown in FIG. 14, a design layer 73 may be provided in advance on the release layer 23 of the substrate sheet element 71. The design layer 73 may be of, for example, a profile of a character as shown in FIG. 15(a), a shape of the character with the inside of the profile being painted plainly as shown in FIG. 15(b), or any other optional design. Namely, the design 72 formed on the release layer 23 of the substrate sheet element 71 by hand drawing or the like may be provided with the pre-formed design 73 side by side, or may be overlapped on the pre-formed design 73. In the case where the design 72 is overlapped on the pre-formed design 73, the design layer 73 should not entirely contain a concealing substance and needs to have light transmissivity in at least a part thereof.

### EXAMPLE 4

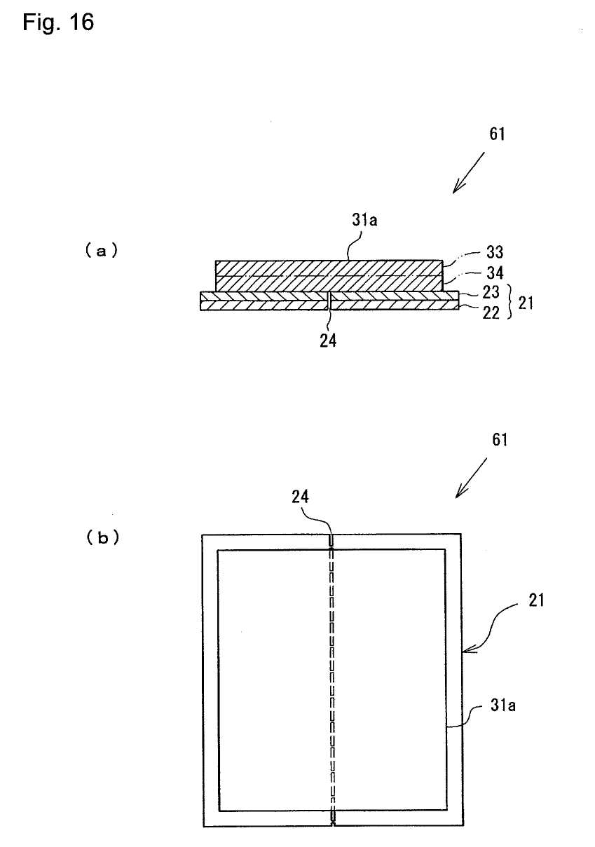

FIG. 16 provides across-sectional view and a plan view schematically showing a structure of a nonthermal transfer sheet manufacturing element 61 according to Example 4.

This nonthermal transfer sheet manufacturing element 61 is also suitable to obtain a transfer design layer 31 desired by a user. Specifically, the nonthermal transfer sheet manufacturing element 61 includes a pre-transfer design layer 31a, which includes an adhesive layer 34 and a transfer layer 33 integrated together in advance, and a substrate sheet 21 for supporting the pre-transfer design layer 31a. A design is drawn by, for example, hand drawing or an inkjet printer on the transfer layer 33, and a transfer layer 33 having the design integrated therein is formed.

The substrate sheet 21 includes a substrate layer 22 and a release layer 23 formed thereon, and basically has the same structure as that of the substrate sheet 21 in Example 1. Note that the substrate sheet 21 has perforations 24 as tearing means for tearing the substrate sheet 21 (see FIG. 16(a)). The perforations 24 are formed as, for example, a line passing the center of the adhesive layer 34 and the transfer layer 33 (see FIG. 16(b)). The perforations 24 are provided for the convenience of transfer.

The structure of the adhesive layer 34 and the transfer layer 33 is substantially the same as that of Example 1. The adhesive layer 34 and the transfer layer 33 may have an optional shape of an abstract or realistic design. The adhesive layer 34 and the transfer layer 33 are integrated together by a heating and pressurization treatment.

In the case where, for example, a design desired by the user is formed by an inkjet printer, an ink receiving layer (not shown) or the like is formed on a top surface of the transfer layer as necessary so as to provide a surface suitable to printing.

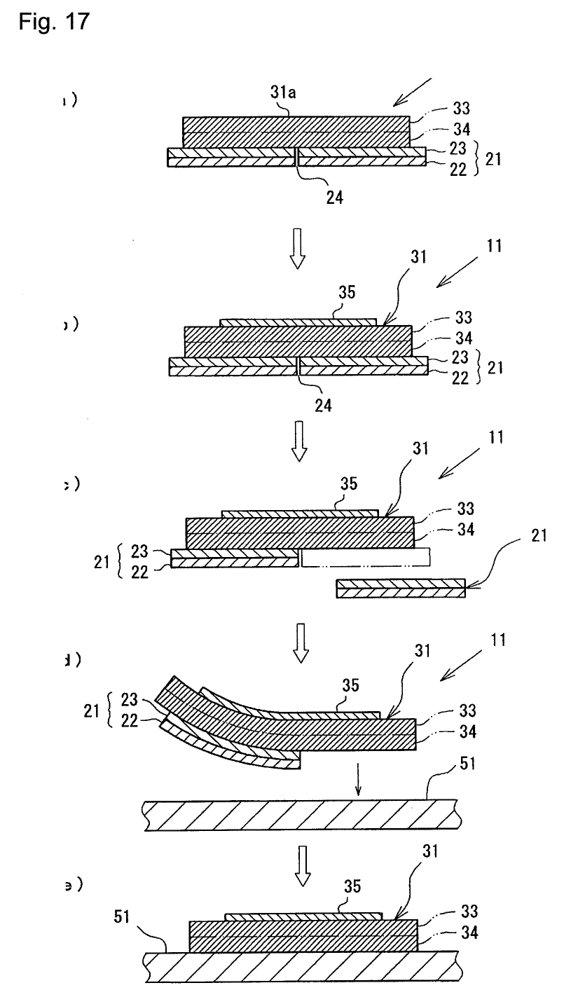

Using the nonthermal transfer sheet manufacturing element 61, a nonthermal transfer sheet 11 is manufactured as shown in FIG. 17 and used. Specifically, the nonthermal transfer sheet manufacturing element 61 is prepared (see FIG. 17(a)). The nonthermal transfer sheet 11, having a design 35 desired by the user formed on the surface of the transfer layer 33 by appropriate means, is obtained (see FIG. 17(b)) The transfer layer 33 and the adhesive layer 34 are integrated together in advance as the pre-transfer design layer 31a by the heating and pressurization treatment, and so does not need to be subjected to heating and pressurization again. In order to fix the design 35 more securely, another heating and pressurization treatment may be performed as necessary.

After this, a part of the substrate sheet 21 is cut off along the perforations 24 (see FIG. 17(c)), and the part deprived of the substrate sheet 21 is put and pasted on a transfer subject 51 (see FIG. 17(d)). The pre-transfer design layer 31a including the transfer layer 33 is extendable. Therefore, the substrate sheet 21 can be easily cut off by pulling the substrate sheet 21 in the direction in which the part is to be cut off. Finally, the remaining substrate sheet 21 is removed, and the entirety of the transfer design layer 31 is pasted on the transfer subject 51 (see FIG. 17(e)).

The nonthermal transfer sheet 11 manufactured using the nonthermal transfer sheet manufacturing element 61 having the above-described structure is used in substantially the same manner, and provides substantially the same function and effect, as in Example 1.

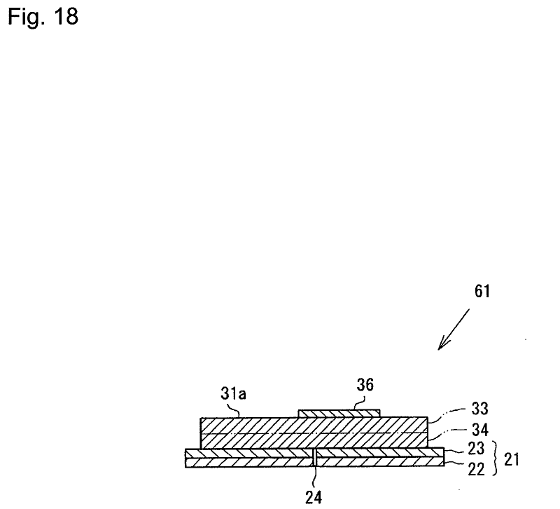

In this case also, as shown in FIG. 18, a design layer 36 may be provided in advance on the release layer 33. The design layer 36 may be of, for example, a profile of a character as shown in FIG. 15(a), a shape of the character with the inside of the profile being painted plainly as shown in FIG. 15(b), or any other optional design. Namely, the design 35 formed on the release layer of the substrate sheet 21 by hand drawing or the like may be provided with the pre-formed design 36 side by side, or may be overlapped on the pre-formed design 36. In the case where the design 35 is overlapped on the pre-formed design 36, the design layer 36 may entirely contain a concealing substance and does not need to have light transmissivity.

1. A nonthermal transfer sheet, wherein:
a multi-color design layer is formed on a top surface of a known and ready-made substrate sheet including a substrate layer and a release layer formed thereon;
a transfer layer for covering the multi-color design layer is provided;
the transfer layer is formed of a thermoplastic resin containing polyurethane or the like as a main component,
an adhesive layer is stacked on the transfer layer;
the adhesive layer is formed of an acrylic adhesive; and
a stack of these layers is entirely treated with heating and pressurization.

2. A nonthermal transfer sheet, comprising:
a substrate sheet including a substrate layer and a release layer formed on a top surface of the substrate layer;
a design layer provided on the release layer of the substrate sheet; and
a transfer layer for covering the layer and an adhesive layer stacked on the transfer layer;
wherein:
the transfer layer is formed of a thermoplastic resin containing polyurethane as a main component;
the adhesive layer is formed of an adhesive containing an acrylic adhesive; and
the substrate sheet, the design layer, the transfer layer and the adhesive layer are treated with heating and pressurization, as a result of which, the design layer, the transfer layer and the adhesive layer are integrated together.

3. A nonthermal transfer sheet, comprising:
a substrate sheet including a substrate layer and a release layer formed on a top surface of the substrate layer;
a transfer layer provided on the release layer of the substrate sheet; and
an adhesive layer stacked on the transfer layer;
wherein:
the transfer layer is formed of a thermoplastic resin containing polyurethane as a main component;
the adhesive layer is formed of an adhesive containing an acrylic adhesive;
the transfer layer and/or the adhesive layer contains a concealing substance; and
the substrate sheet, the transfer layer and the adhesive layer are treated with heating and pressurization, as a result of which, the design layer, the transfer layer and the adhesive layer are integrated together.

4. A method for manufacturing a nonthermal transfer sheet, comprising: a step of forming a multi-color design layer on a known and ready-made substrate sheet by means of any of various types of printers, screen printing, hand drawing or the like (first step); a step of forming a transfer layer, formed of a thermoplastic resin containing polyurethane or the like as a main component, on the multi-color design layer formed by the first step (second step); a step of forming an adhesive layer, containing an acrylic adhesive, on the transfer layer formed by the second step (third step); and a step of covering, with an adhesive layer protective sheet, a surface, on the adhesive layer side, of a pre-heating and pressurization transfer sheet formed by the above steps, and then while keeping this state, treating the entirety of the pre-heating and pressurization transfer sheet with heating and pressurization (fourth step).

5. A method for manufacturing a nonthermal transfer sheet, comprising:
a design layer forming step of forming a design layer on a release layer of a substrate sheet including a substrate layer and the release layer formed on a top surface of the substrate layer;
a transfer layer forming step of forming a transfer layer, formed of a thermoplastic resin containing polyurethane as a main component, on the design layer formed by the design layer forming step;
an adhesive layer forming step of forming an adhesive layer, containing an acrylic adhesive, on the transfer layer formed by the transfer layer forming step; and
a heating and pressurization step of covering the adhesive layer formed by the adhesive layer forming step with an adhesive layer protective sheet, and then performing a heating and pressurization treatment in this state to integrate the design layer, the transfer layer and the adhesive layer.

6. A method for manufacturing a nonthermal transfer sheet, comprising:
a transfer layer forming step of forming a transfer layer, formed of a thermoplastic resin containing polyurethane as a main component, on a release layer of a substrate sheet including a substrate layer and the release layer formed on a top surface of the substrate layer;
an adhesive layer forming step of forming an adhesive layer, containing an acrylic adhesive, on the transfer layer formed by the transfer layer forming step; and
a heating and pressurization step of covering the adhesive layer formed by the adhesive layer forming step with an adhesive layer protective sheet, and then performing a thermal press treatment in this state to integrate the transfer layer and the adhesive layer;
wherein the transfer layer and/or the adhesive layer contains a concealing substance.

7. A nonthermal transfer sheet manufacturing element, comprising:
a substrate sheet element including a substrate layer and a release layer formed on a top surface of the substrate layer; and
a cover sheet element including an adhesive layer containing an acrylic adhesive, a transfer layer formed of a thermoplastic resin containing polyurethane as a main component, and an adhesive layer protective sheet provided on the adhesive layer, among the adhesive layer and the transfer layer which are stacked on each other;
wherein the design layer provided on the release layer of the substrate sheet element, and the transfer layer and the adhesive layer of the cover sheet element, are integrated together by heating and pressurization.

8. A nonthermal transfer sheet manufacturing element, comprising:
a substrate sheet including a substrate layer and a release layer formed on a top surface of the substrate layer;
an adhesive layer formed, of an adhesive containing an acrylic adhesive, on the release layer of the substrate sheet; and
a transfer layer formed, of a thermoplastic resin containing polyurethane as a main component, on the adhesive layer;
wherein:
the adhesive layer and the transfer layer are integrated together by heating and pressurization; and
the substrate sheet is provided with tearing means for tearing the substrate sheet.
